(19) United States
(12) Patent Application Publication
(10) Pub. No.: US 2004/0265042 A1
(43) Pub. Date: Dec. 30, 2004

(54) Fulid-dispensing cleaning tool

(75) Inventors: David Chan, Scarborough (CA); Matthew Frank, Seattle, WA (US)

Correspondence Address: BANNER & WITCOFF, 1001 G STREET N W, SUITE 1100, WASHINGTON, DC, 20001, US

(73) Assignee: Browne & Co., Markham (CA)

(21) Appl. No.: 10/831,339

(22) Filed: Apr. 26, 2004

Related U.S. Application Data
(60) Provisional application No. 60/465,202, filed on Apr. 25, 2003.

(51) Int. Cl. B43K 5/14; A46B 11/04; B43K 5/02

(52) U.S. Cl. 401/270; 401/205; 401/188 R

(57) ABSTRACT

A fluid-dispensing cleaning tool is described comprising a body defining a fluid reservoir within it and a pump assembly carried by the body in fluid communication with the fluid reservoir for dispensing fluid to a cleaning head attached to the body. The pump assembly is operable to control the dispensing of the fluid from the reservoir to the cleaning head. The cleaning head may be releasably attached to the tool.

### FIELD OF THE INVENTION

The present invention relates to a fluid-dispensing cleaning tool and more particularly to a fluid-dispensing cleaning tool that includes a pump assembly for controlled release of the fluid.

### BACKGROUND OF THE INVENTION

Cleaning tools are known that include reservoirs for cleaning fluid such as liquid soaps. Examples of such cleaning tools include soap-dispensing kitchen scrub brushes. Generally these cleaning tools include a body with a reservoir which contains the fluid to be dispensed and a cleaning portion of the body through which the fluid is to be dispensed. A valve that is attached to the reservoir works between an open position which allows the fluid to pass out of the reservoir to the cleaning portion, and a closed position which prevents the fluid from leaving the reservoir. The valves in such devices are usually mechanical valves that are displaceable between two positions to achieve the open and closed position.

Mechanical valves generally do not allow for accurate dispensing of fluid amounts and can lead to excess fluid passing through the valve. This can lead to fluid build up around the valve which may lead to clogging of the valve, and leaking of the fluid.

The cleaning portion of such soap-dispensing brushes can also become clogged with any excess fluid that may build up over time and therefore replacement brushes may be required. Further, different cleaning portions may be desired for different soils or materials to be cleaned.

It is therefore desirable to provide a cleaning tool that addresses some of these shortcomings.

### SUMMARY OF THE INVENTION

The present invention provides a fluid-dispensing cleaning tool. In accordance with a first aspect, the tool comprises a body defining a fluid reservoir within it and a pump assembly carried by the body in fluid communication with the fluid reservoir for dispensing fluid external to the body to a cleaning head when attached to the body. The pump assembly is operable to control the dispensing of the fluid from the reservoir to the cleaning head.

In accordance with a second aspect, there is provided a fluid-dispensing cleaning tool comprising a body defining a fluid reservoir therein, mounting means carried on the body for releasably mounting a cleaning head to the body and a pump assembly carried by the body. The pump assembly is in fluid communication with the fluid reservoir for dispensing fluid external to the body to a cleaning head when attached to the body. The pump assembly is operable to control the dispensing of the fluid from the reservoir to the cleaning head.

In accordance with either aspect, the tool may include a handle.

### DESCRIPTION OF THE DRAWINGS

The present invention will be better understood with reference to the attached description and to the drawings in which:

FIG. 1 is a side cross-sectional view of an embodiment of the fluid-dispensing cleaning tool of the present invention;

FIG. 2 is a side elevational view of the fluid-dispensing cleaning tool of FIG. 1;

FIG. 3 is a top view of the fluid-dispensing cleaning tool of FIG. 1;

FIG. 4 is a bottom view of the fluid-dispensing tool of FIG. 1;

FIG. 5 is a front plan view of the fluid-dispensing cleaning tool of FIG. 1;

FIG. 6 is a side cross-sectional of an alternative embodiment of the fluid-dispensing cleaning tool of the present invention;

FIG. 7 is a top perspective view of the fluid-dispensing cleaning tool of FIG. 6;

FIG. 8 is a rear view of the fluid-dispensing cleaning tool of FIG. 6;

FIG. 9 is a top perspective view of a further alternative embodiment of a cleaning tool having a handle;

FIG. 10 shows one embodiment of a cleaning head for the fluid-dispensing cleaning tools of FIGS. 1-8.

### DESCRIPTION OF THE DRAWINGS

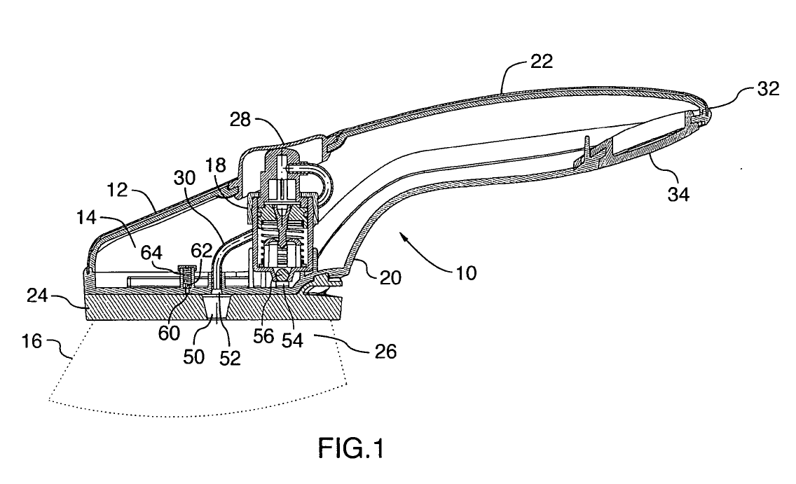

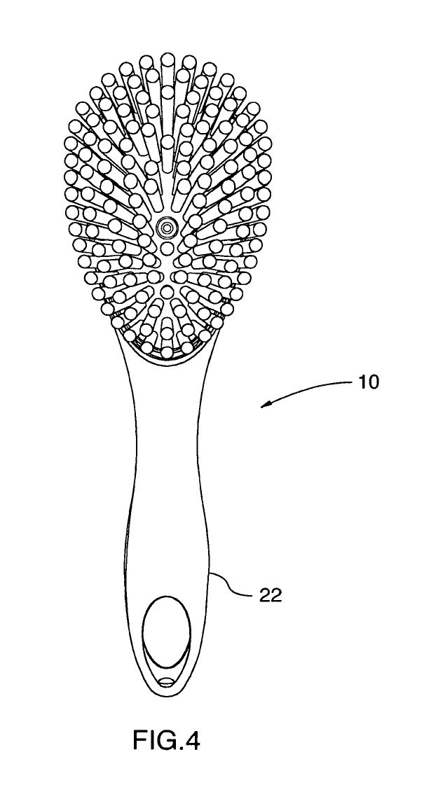

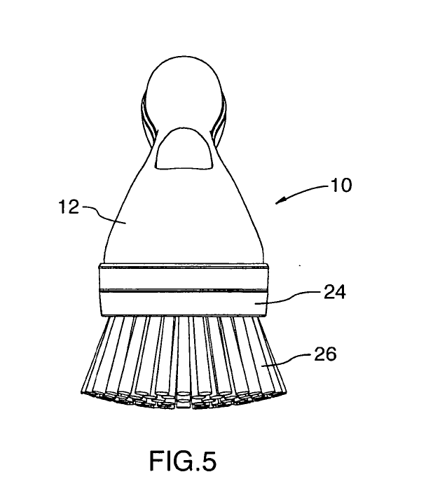

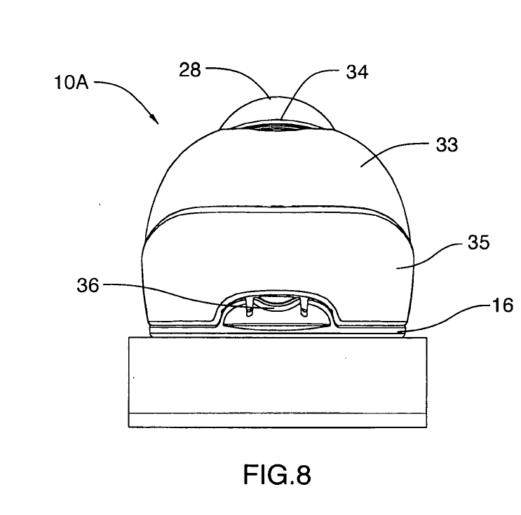

Various embodiments of the present invention will now be described with reference to FIGS. 1 through 9. Turning first to FIGS. 1 through 5 and more particularly FIG. 1, there is shown an embodiment of the fluid-dispensing cleaning tool 10 having a handle portion 22. The fluid-dispensing cleaning tool 10 comprises a body 12 defining a fluid reservoir 14, and a pump assembly 18 carried by the body 12. The pump assembly 18 is in fluid communication with the fluid reservoir 14 and is for dispensing fluid external to the body to a cleaning head 16. The pump assembly 18 is operable to control the dispensing in of fluid from the reservoir 14 to the cleaning head 16. When not in use, the pump is in a closed position in which fluid is contained within the reservoir 14.

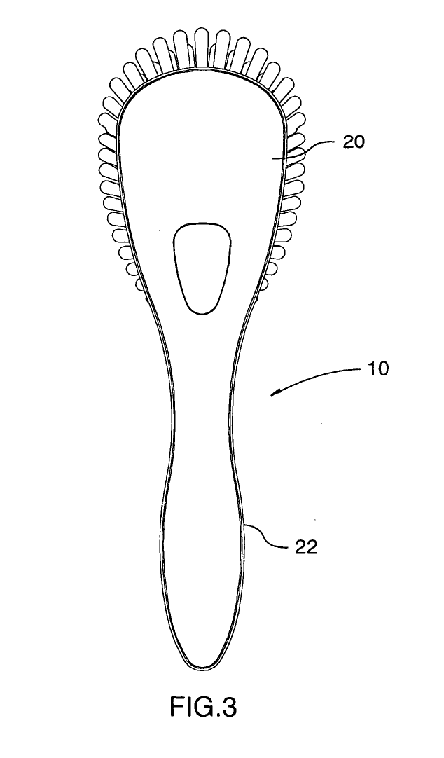

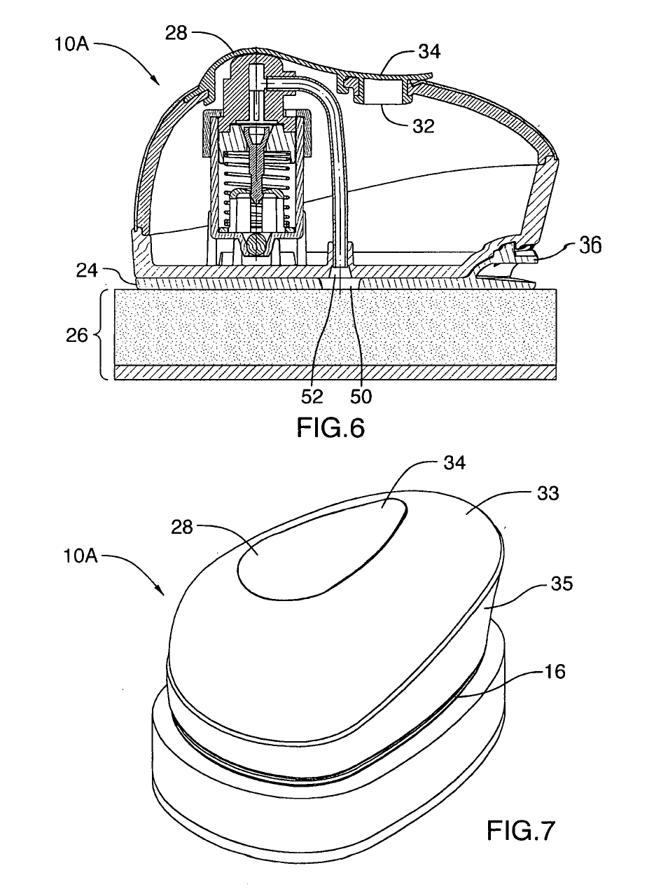

As can be seen more clearly in FIG. 3, the body 12 includes a main portion 20 and handle portion 22. As will be described in an alternative embodiment shown in FIGS. 6 through 8, the body need not include a handle portion 22. As can be seen more clearly in FIG. 1, the main portion 20 defines the fluid reservoir 14. The fluid reservoir 14 may generally conform to the shape and size of the main portion 20 and the handle portion 22 or it may alternatively form a smaller internal chamber of a different shape and size.

Carried on the body 12 is a pump assembly 18 which, as stated above, is in fluid communication with the fluid reservoir 14 drawing fluid in through pump intake 54 up to a fluid passageway 30 (e.g. a tube). A valve ball 56 closes pump intake 54 when the pump assembly 18 is not in use. Pump assembly 18 is also in fluid communication with the cleaning head 16, via passageway 30 to a dispensing aperture 52 in body 12. The pump assembly 18 is operable using actuating member 28 to control the dispensing to the fluid from the fluid reservoir 14 to the cleaning head 16. The actuating member 28 may take any form, as will be understood by a person skilled in the art, for example a button or a switch. Pump assembly 18 provides a known maximum amount of fluid, defined relative to the volume of the pump assembly, with each depressing of the actuating member (once the pump is primed). This controlled release of the fluid by the pump assembly 18 prevents excess fluid from passing from the reservoir 14 to the cleaning head 16 thereby preventing clogging of the cleaning head 16 and the passageway 30. Persons of ordinary skill in the art will appreciate that other pumps may be substituted for the plunger and spring assembly shown. In accordance with a preference, there is provided an intake aperture 60 in body 12 having a ball valve 62 and spring 64 closure to assist with pumping, permitting air to more easily enter reservoir 14.

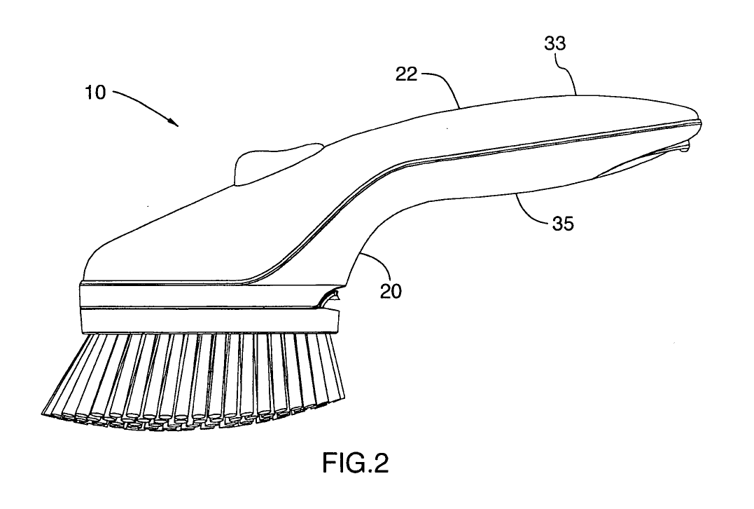

The body 12 also includes a refill aperture 32 in fluid communication with the fluid reservoir 14 through which fluid may be refilled. In the embodiment of FIGS. 1-5, the refill aperture 32 is located on the handle portion 22 of the body 12. However, it will be understood that the refill aperture 32 may be located at any position on the body 12 provided it is in fluid communication with the reservoir 14. The body 12 also includes a cap 34 operable to releasably seal the refill aperture 32. The cap 34 is sized to be received in the refill aperture 32. When the fluid is being refilled the cap 34 is removed from the refill aperture 32, and once the fluid has been refilled the cap 34 is replaced to seal the refill aperture 32. As seen in FIG. 2, body 12 comprises an upper portion 33 and a lower portion 35. In accordance with a preferred embodiment, the portions 33, 35 may be constructed of dissimilar materials such as stainless steel (upper) and a polycarbonate (lower) which may be transparent to view reservoir 14.

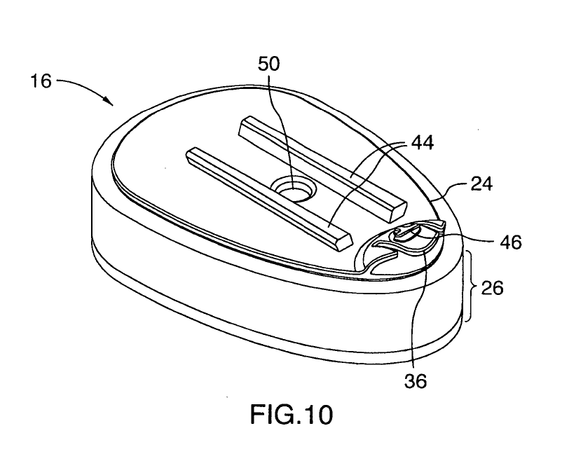

Preferably, cleaning head 16 is releasably attached to the body 12 about the main portion 20. The cleaning head 16 has an upper portion 24 which is operable to connect to the body 12 and a lower portion 26 which comprises a cleaning instrument. Examples of suitable cleaning instruments include, but are not limited to, bristles such as illustrated in FIG. 2, which bristles may be hard, soft or a combination thereof, sponges and/or scrubbing media or combinations thereof such as a mildly abrasive material as shown in FIG. 10 well known in the art.

Cleaning heads are interchangeable to mount different cleaning instruments for different tasks and may take any form that is operable to provide a cleaning instrument. The head 16 and the body 12 may be connected by any means known by a person skilled in the art that will allow for easy separation of the head 16 and the body 12 when desired yet sufficient adhesion when the tool is worked to avoid undesired disconnection. For example, the head 16 may be connected to the body 12 by a sliding connection. The body 12 may include or define a mounting member, such as one or more channels (not shown), that correspond to a mating member such as one or more rails 44 located on the cleaning head 16 as illustrated in FIG. 10. Of course, head 16 may define channels and body 12 define may cooperating rails. The corresponding mounting members are operable to connect when the head 16 is slid on the body 12. A snap fit connector (e.g. 46) on one of the body 12 and head 16 may engage with a cooperating position (not shown) on the other of the head 16 and body 12 when the head is in place and be operable to release when required. The cleaning head 16 (or body 12) may include a releasing mechanism, such as a button or tab 36, to release the head 16 from the body 12.

Upper portion 24 of cleaning head 16 may define a passage (e.g. an aperture) 50 cooperating with dispensing aperture 52 of body 12 to deliver dispensed fluid to the cleaning instrument. The interchangeable head 16 provides a longer life for the cleaning tool 10 since when the head 16 has been sufficiently used it can be replaced without having to discard the whole tool 10. As well, different cleaning instruments extend the range of cleaning duties for tool 10.

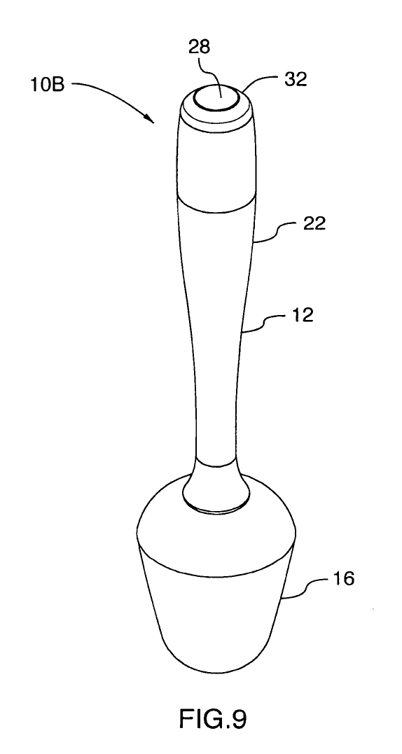

Turning now to FIGS. 6 through 8, an alternative embodiment 10A is illustrated. The alternative embodiment 10A differs from tool embodiment 10 discussed above in that the body 12 does not include a handle portion 22. FIGS. 6 through 8 show the tool 10A mounted to a head having a cleaning instrument 26 comprising a sponge and abrasive material for purposes of illustration only. With reference to FIG. 9, there is shown yet a further embodiment 10B including a handle portion 22. Tool 10B is similar to tool 10 in that tool 10B comprises an internal pump assembly (not shown in FIG. 10) carried by body 12 and a handle potion 22; however, the head 16 mounts about an end of body 12 opposite the handle portion in a more linear fashion, directing the head 16 along the axis of handle portion 12. As well, pump assembly 18 may be carried within handle portion 22. Tool 10B may facilitate cleaning of glassware, bottles, vases and the like having a relatively narrow opening through which to fit the head of the tool.

The above embodiments may be made from any material that is suitable for a cleaning tool as will be known by a person skilled in the art. Examples of such materials include, for example, but are not limited to, stainless steel or polycarbonate, which polycarbonate may be transparent, or both for the body 12, and non-slip silicone for the actuating member 28 and refill cap 34.

In use, a fluid such as water, soap, cleanser or the like is filled into reservoir 14 via refill aperture 32 and the cap 24 closed. A desired cleaning head 16 is mounted on the body 12. Pump 18 is actuated via actuation member 28, depressing and releasing the actuating member 28 one or more times to pump the fluid through the pump 18 and fluid passageway 30 to dispensing aperture 52. There the fluid exits through body 12 to cleaning head 16 for application to a surface to be cleaned. Pumping may be repeated to further dispense fluid in a controlled manner as needed. The head 16 may be removed and a further head 16 applied as desired. As pump assembly 18 provides a closure between reservoir 14 and dispensing aperture 52, the tool itself may be washed or submerged in water without unintentionally filling the reservoir with an undesired fluid.

The above-described embodiments of the invention are intended to be examples of the present invention and alterations and modifications may be effected thereto, by those of skill in the art, without departing from the scope of the invention which is defined by the claims appended hereto.

1. A fluid-dispensing cleaning tool comprising:
a body defining a fluid reservoir therein; and
a pump assembly carried by the body in fluid communication with the fluid reservoir for dispensing fluid external to the body to a cleaning head when attached to the body, the pump assembly being operable to control the dispensing of the fluid from the reservoir to the cleaning head.

2. A fluid-dispensing cleaning tool according to claim 1, wherein the fluid reservoir further comprises a refill aperture and a cap operable to close the refill aperture.

3. A fluid-dispensing cleaning tool according to claim 1 wherein the body comprising a dispensing aperture in communication with the pump assembly through which the fluid is dispensed.

4. A fluid-dispensing cleaning tool according to claim 1, wherein the tool further comprises a cleaning head attached to the body.

5. A fluid-dispensing cleaning tool according to claim 4, wherein the cleaning head is releasably attached to the body.

6. A fluid-dispensing cleaning tool according to claim 1, wherein one of the body and cleaning head comprises a release mechanism for releasing the cleaning head from the body.

7. A fluid-dispensing cleaning tool according to claim 1, wherein the pump assembly further comprises an actuating member operable to actuate the pump assembly.

8. A fluid-dispensing cleaning tool according to claim 1, wherein the cleaning head comprises at least one of hard bristles, soft bristles, a sponge and a scrubbing medium.

9. A fluid-dispensing cleaning tool according to claim 1, further comprising a handle attached to the body.

10. A fluid-dispensing cleaning tool according to claim 9, further comprising a cleaning head attached to the body and extending axially of the handle.

11. A fluid-dispensing cleaning tool comprising:
i. a body defining a fluid reservoir therein;
ii. mounting means carried on the body for releasably mounting a cleaning head to the body; and
iii. a pump assembly carried by the body in fluid communication with the fluid reservoir for dispensing fluid to a cleaning head when attached to the body, the pump assembly being operable to control the dispensing of the fluid from the reservoir to the cleaning head.

12. A fluid-dispensing cleaning tool according to claim 11, wherein the fluid reservoir further comprises a refill aperture and a cap operable to close the aperture.

13. A fluid-dispensing cleaning tool according to claim 12, wherein the tool further comprises a cleaning head attached to the body.

14. A fluid-dispensing cleaning tool according to claim 13, wherein the cleaning head comprises corresponding mounting means for attachment of the cleaning head to the body.

15. A fluid-dispensing cleaning tool according to claim 11, wherein the pump assembly further comprises an actuating member operable to actuate the pump assembly.

16. A fluid-dispensing cleaning tool according to claim 11, wherein the cleaning head comprises at least one of hard bristles, soft bristles, a sponge and a scrubbing medium.

17. A fluid-dispensing cleaning tool according to claim 11, further comprising a handle attached to the body.

18. A fluid-dispensing cleaning tool according to claim 17, further comprising a cleaning head attached to the body and extending axially of the handle.
